(19) United States
(12) Patent Application Publication
(10) Pub. No.: US 2026/0056435 A1
(43) Pub. Date: Feb. 26, 2026

(54) DISPLAY DEVICE AND HEAD-UP DISPLAY

(71) Applicant: Japan Display Inc., Tokyo (JP)

(72) Inventors: Takayuki KATO, Tokyo (JP); Shinichiro TANAKA, Tokyo (JP); Kazunari TOMIZAWA, Tokyo (JP)

(73) Assignee: Japan Display Inc., Tokyo (JP)

(21) Appl. No.: 19/304,670

(22) Filed: Aug. 20, 2025

(30) Foreign Application Priority Data
Aug. 21, 2024 (JP) 2024-139803

(51) Int. Cl. G02F 1/1347; G02B 27/01; G02F 1/1333; G02F 1/1343; G02F 1/1362; G02F 1/1368

(52) U.S. Cl. CPC G02F 1/1347; G02B 27/0101; G02F 1/133388; G02F 1/134309; G02F 1/136286; G02F 1/1368

(57) ABSTRACT

According to an aspect, a display device includes: a backlight, a first liquid crystal display panel, and a second liquid crystal display panel. The first liquid crystal display panel includes a display region. The second liquid crystal display panel includes a display region and a non-display region. The display region of the first liquid crystal display panel overlaps the non-display region of the second liquid crystal display panel when viewed in at least one direction in which the first and second liquid crystal display panels are placed so as to overlap each other. The display region of the first liquid crystal display panel is provided with at least a liquid crystal layer, a polarizing plate, and a color filter. The non-display region of the second liquid crystal display panel is provided with at least a liquid crystal layer and a polarizing plate and is not provided with a color filter.

### CROSS-REFERENCE TO RELATED APPLICATION

This application claims the benefit of priority from Japanese Patent Application No. 2024-139803 filed on Aug. 21, 2024, the entire contents of which are incorporated herein by reference.

### BACKGROUND

### 1. Technical Field

What is disclosed herein relates to a display device and a head-up display.

### 2. Description of the Related Art

There has been known a head-up display (HUD) that projects an image onto a light-transmissive member such as glass or the like and allows the image reflected by the light-transmissive member to be visually recognized as a virtual image by a viewer (for example, Japanese Patent Application Laid-open Publication No. 2004-168230 (JP-A-2004-168230)).

In such a HUD, the spatial position of the virtual image visually recognized by the viewer depends on relative position between a display panel, a reflection member, and the viewpoint of the viewer. Specifically, the distance from the viewpoint of the viewer to the virtual image increases as the distance between the display panel and the reflection member increases, and the distance from the viewpoint of the viewer to the virtual image decreases as the distance between the display panel and the reflection member decreases. In JP-A-2004-168230, a plurality of display panels are vertically stacked at intervals, and different output images are displayed on the respective display panels, so that the distances from the viewpoint of the viewer to virtual images of the respective output images are different from each other.

In the above-described conventional technology, display regions of the display panels are disposed so as not to overlap when viewed in the line-of-sight direction of the viewer, and regions other than the display regions are transparent. In such a configuration, for example, it may be considered to stack identical display panels and not to perform alignment control of a liquid crystal layer in the region other than the display region of each display panel. In this case, for example, in a display image in the display region of a second display panel overlapping a region other than the display region of a first display panel, chromaticity may change and luminance may decrease due to light passing through pixels and color filters provided in the region other than the display region of the first display panel, which potentially leads to degradation of display quality.

For the foregoing reasons, there is a need for a display device and a head-up display that can reduce degradation of display quality.

### SUMMARY

According to an aspect, a display device includes: a backlight; a first liquid crystal display panel on which direct light from the backlight is incident; and a second liquid crystal display panel that is placed, with a gap interposed between the first liquid crystal display panel and the second liquid crystal display panel, so as to overlap the first liquid crystal display panel and on which transmitted light from the first liquid crystal display panel is incident. The first liquid crystal display panel includes a display region for displaying an image. The second liquid crystal display panel includes a display region for displaying an image and a non-display region for not displaying an image. The display region of the first liquid crystal display panel overlaps the non-display region of the second liquid crystal display panel when viewed in at least one direction in which the first and second liquid crystal display panels are placed so as to overlap each other. The display region of the first liquid crystal display panel is provided with at least a liquid crystal layer, a polarizing plate, and a color filter. The non-display region of the second liquid crystal display panel is provided with at least a liquid crystal layer and a polarizing plate and is not provided with a color filter.

According to an aspect, a head-up display is configured to cause a viewer to visually recognize, as a virtual image, an image reflected by a light-transmissive member that transmits and reflects incident light and superimposed on a real image transmitted through the light-transmissive member. The head-up display includes: the display device according to claim 1; and a magnification optical system that magnifies an image displayed on the display device and projects the image onto the light-transmissive member. A polarizing plate provided in the first liquid crystal display panel and a polarizing plate provided in the second liquid crystal display panel are disposed such that transmission axes of the polarizing plates are orthogonal to each other with respect to incident light. A liquid crystal layer provided in the first liquid crystal display panel and a liquid crystal layer provided in the second liquid crystal display panel are initially aligned such that transmittances of the first and second liquid crystal display panels are maximized.

### BRIEF DESCRIPTION OF THE DRAWINGS

FIG. 1 is a schematic diagram of a head-up display, illustrating an example of application of a display device according to an embodiment;

FIG. 2A is a schematic diagram illustrating a basic configuration of the HUD;

FIG. 2B is a schematic diagram illustrating an equivalent configuration of the HUD illustrated in FIG. 2A;

FIG. 3 is a diagram illustrating the relation between a distance “a” between a panel and a lens, and a virtual distance VID between a viewpoint and a virtual image;

FIG. 4 is a schematic diagram illustrating an equivalent configuration of the HUD;

FIG. 5A is a schematic circuit diagram illustrating a main configuration of a first liquid crystal display panel;

FIG. 5B is a schematic circuit diagram illustrating a main configuration of a second liquid crystal display panel;

FIG. 6A is a schematic sectional view of a display region of the first liquid crystal display panel;

FIG. 6B is a schematic sectional view of a display region of the second liquid crystal display panel;

FIG. 7A is a schematic sectional view of a non-display region of the first liquid crystal display panel;

FIG. 7B is a schematic sectional view of a non-display region of the second liquid crystal display panel;

FIG. 8 is a diagram illustrating a display aspect of a first image in a first example;

FIG. 9 is a diagram illustrating a display aspect of a second image in the first example;

FIG. 10 is a sectional view of the display device according to the embodiment along line A-A illustrated in FIGS. 8 and 9, viewed in the direction of arrows;

FIG. 11 is a diagram illustrating a virtual image visually recognized by a viewer in the first example;

FIG. 12 is a diagram illustrating the display aspect of the first image in a second example;

FIG. 13 is a diagram illustrating the display aspect of the second image in the second example;

FIG. 14 is a diagram illustrating the virtual image visually recognized by the viewer in the second example;

FIG. 15 is a diagram illustrating the display aspect of the first image in a third example;

FIG. 16 is a diagram illustrating the display aspect of the second image in the third example;

FIG. 17 is a sectional view of the display device according to the embodiment along line B-B illustrated in FIGS. 15 and 16, viewed in the direction of arrows;

FIG. 18 is a diagram illustrating the virtual image visually recognized by the viewer in the third example;

FIG. 19 is a schematic diagram of a HUD, illustrating an example of application of a display device according to a first modification of the embodiment; and

FIG. 20 is a schematic diagram of a HUD, illustrating an example of application of a display device according to a second modification of the embodiment.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is only an example, and any modifications that can be easily conceived by those skilled in the art while maintaining the main purpose of the disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

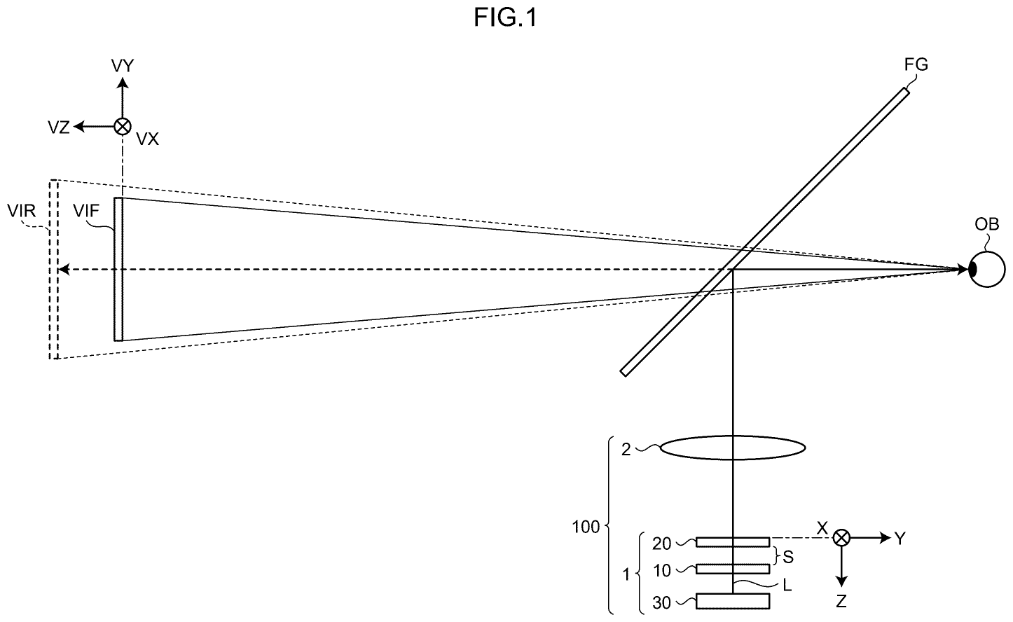

FIG. 1 is a schematic diagram of a head-up display, illustrating an example of application of a display device according to the embodiment. A head-up display (hereinafter also simply referred to as “HUD”) 100 includes a display device 1 and a magnification optical system 2 that magnifies an image displayed on the display device 1 and projects the image onto a light-transmissive member FG.

The light-transmissive member FG is a light-transmissive member such as glass or resin. Examples of the light-transmissive member FG include, but are not limited to, a windshield of a vehicle and a combiner. The light-transmissive member FG may be any member that transmits and reflects incident light and is not limited to a windshield of a vehicle or a combiner.

Examples of the magnification optical system 2 include a lens. The magnification optical system 2 is not limited thereto, and one magnification optical system 2 may be composed of a plurality of optical members such as planar mirrors or concave mirrors.

The display device 1 includes, as main constituent components, a first liquid crystal display panel 10 that displays a first image, a second liquid crystal display panel 20 that displays a second image, and a backlight 30.

The backlight 30 emits planar light (light L) toward the first liquid crystal display panel 10. As illustrated with a solid arrow in FIG. 1, the light L emitted from the backlight 30 passes through the first liquid crystal display panel 10, the second liquid crystal display panel 20, and the magnification optical system 2 in the stated order and is reflected by the light-transmissive member FG, whereby the light L reaches the viewpoint of a viewer OB.

The first liquid crystal display panel 10 and the second liquid crystal display panel 20 overlap when viewed in the optical axis direction of the magnification optical system. In other words, the first liquid crystal display panel 10 and the second liquid crystal display panel 20 overlap when viewed in a line-of-sight direction in which the image of the display device 1 reflected by the light-transmissive member FG is viewed from the viewpoint of the viewer OB. Accordingly, a position where an image on the first liquid crystal display panel 10 reflected by the light-transmissive member FG is visually recognized by the viewer OB and a position where an image on the second liquid crystal display panel 20 reflected by the light-transmissive member FG is visually recognized by the viewer OB coincide with each other in a direction illustrated with a dashed arrow in FIG. 1.

In the following description, an image displayed on the first liquid crystal display panel 10 is also referred to as a “first image”, and an image displayed on the second liquid crystal display panel 20 is also referred to as a “second image”. An image of the first image reflected by the light-transmissive member FG and visually recognized by the viewer OB is also referred to as a “virtual image VIR”, and an image of the second image reflected by the light-transmissive member FG and visually recognized by the viewer OB is also referred to as a “virtual image VIF”.

Furthermore, in the following description, a virtual distance from the viewpoint of the viewer OB to the virtual image VIR of the first image reflected by the light-transmissive member FG or the virtual image VIF of the second image reflected by the light-transmissive member FG is also simply referred to as a “virtual distance”. Virtual positions of the virtual image VIR of the first image reflected on the light-transmissive member FG and the virtual image VIF of the second image reflected on the light-transmissive member FG are also simply referred to as “virtual positions”.

In the present disclosure, the “optical axis of the magnification optical system” means not the individual optical axis of each optical member in a case where the magnification optical system 2 is composed of a plurality of optical members, but the optical axis of light that passes through one magnification optical system 2 composed of a plurality of optical members and is incident on the second liquid crystal display panel 20.

In the HUD 100 illustrated in FIG. 1, the first liquid crystal display panel 10 and the second liquid crystal display panel 20 are disposed substantially parallel to a plane (X-Y plane) perpendicular to the optical axis of the magnification optical system 2. With this configuration, the virtual image VIR of the first image and the virtual image VIF of the second image, which are visually recognized by the viewer OB, are visually recognized by the viewer OB on a virtual plane (VX-VY plane) substantially parallel to the direction illustrated with the dashed arrow in FIG. 1.

In the HUD 100 illustrated in FIG. 1, the distance from the viewpoint of the viewer OB to the first image displayed on the first liquid crystal display panel 10 is greater than the distance from the viewpoint of the viewer to the second image displayed on the second liquid crystal display panel 20. With this configuration, the virtual image VIR of the first image displayed on the first liquid crystal display panel 10 is visually recognized by the viewer OB at a position farther in the direction illustrated with the dashed arrow in FIG. 1 than the virtual image VIF of the second image displayed on the second liquid crystal display panel 20. In other words, the virtual image VIR of the first image displayed on the first liquid crystal display panel 10 is visually recognized as an image located behind the virtual image VIF of the second image displayed on the second liquid crystal display panel 20.

The following describes the relative positional relation between the virtual images VIR and VIF visually recognized by the viewer OB in the HUD 100.

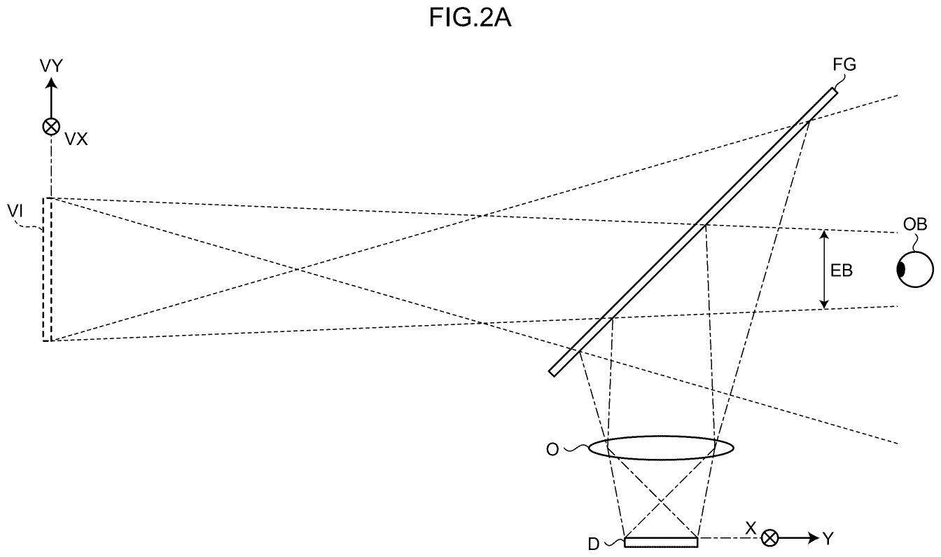

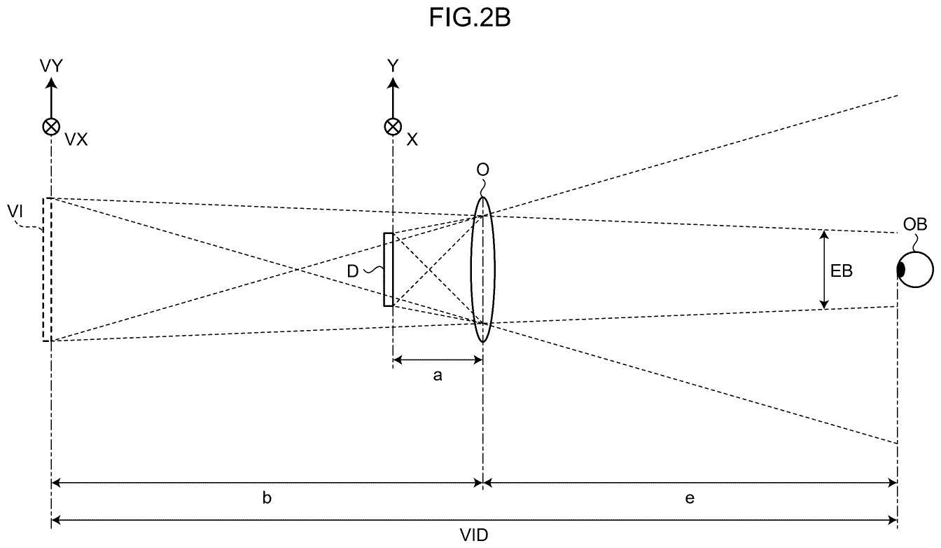

FIG. 2A is a schematic diagram illustrating a basic configuration of the HUD. FIG. 2B is a schematic diagram illustrating an equivalent configuration of the HUD illustrated in FIG. 2A.

An eye box EB illustrated in FIG. 2A represents a range in which the viewer OB can visually recognize a virtual image VI. As illustrated in FIG. 2B, when a lens O and a liquid crystal display panel D of the HUD illustrated in FIG. 2A are arranged in the line-of-sight direction of the viewer OB, a distance “a” (mm) from the liquid crystal display panel D to the center line of the lens O, a virtual distance “b” (mm) from the virtual image VI to the center line of the lens O, and a focal length “f” (mm) of the lens O have a relation expressed by Expression (1) described below. The distance “a” from the liquid crystal display panel D to the center line of the lens O is set to be less than the focal length “f” of the lens O (f>a).

$$\frac{1}{a} - \frac{1}{b} = \frac{1}{f} \qquad ( 1 )$$

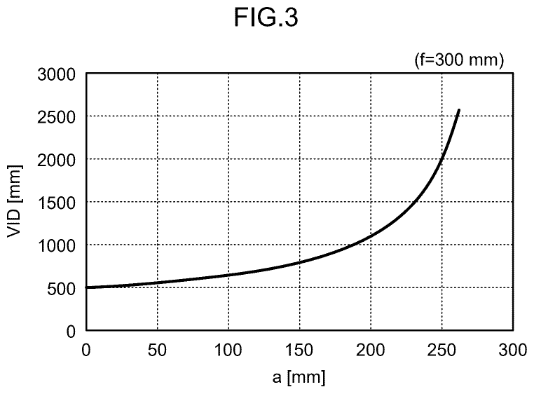

A virtual distance VID (mm) from the viewpoint of the viewer OB to the virtual image VI is expressed by Expression (2) below by using a distance “e” from the center line of the lens O to the viewpoint of the viewer OB. FIG. 3 is a diagram illustrating the relation between the distance “a” between the panel and the lens and the virtual distance VID between the viewpoint and the virtual image.

$$VID = b + e = \frac{fa}{f - a} + e \qquad ( 2 )$$

As indicated by Expression (2) above and FIG. 3, the virtual distance VID from the viewpoint of the viewer OB to the virtual image VI increases as the distance “a” from the liquid crystal display panel D to the center line of the lens O increases. The amount of change in the virtual distance VID from the viewpoint of the viewer OB to the virtual image VI with respect to change in the distance “a” increases as the distance “a” from the liquid crystal display panel D to the center line of the lens O approaches the focal length “f”.

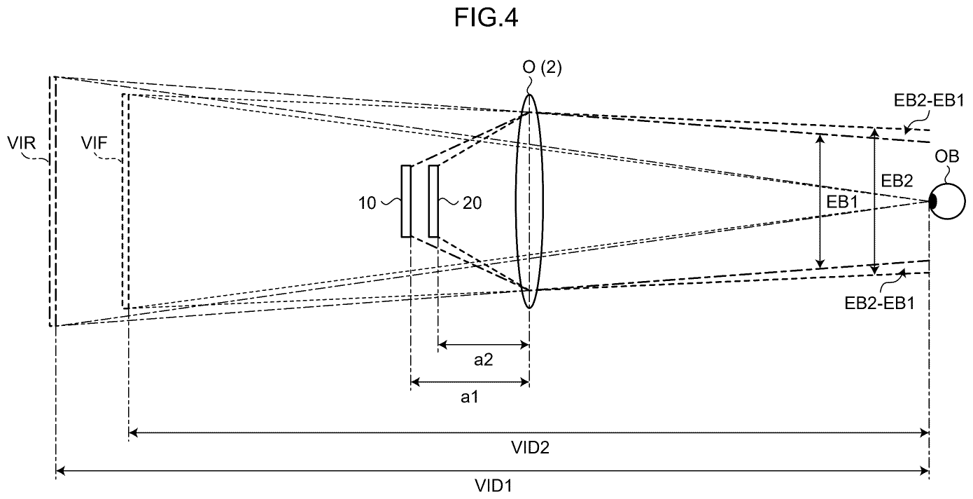

FIG. 4 is a schematic diagram illustrating an equivalent configuration of the HUD. As described above, in a schematic configuration of the HUD 100 illustrated in FIG. 1, the first liquid crystal display panel 10 is disposed farther from the magnification optical system 2 than the second liquid crystal display panel 20 in the optical axis direction of the magnification optical system 2, in other words, in a direction (Z direction) orthogonal to the X-Y plane perpendicular to the optical axis of the magnification optical system 2. Specifically, in the equivalent configuration of the HUD 100 illustrated in FIG. 4, a distance a1 from the first liquid crystal display panel 10 to the center line of the lens O (magnification optical system 2) is greater than a distance a2 from the second liquid crystal display panel 20 to the center line of the lens O (magnification optical system 2) (a1>a2).

A virtual distance VID1 from the viewpoint of the viewer OB to the virtual image VIR of the first image displayed on the first liquid crystal display panel 10 corresponds to the distance a1 from the first liquid crystal display panel 10 to the center line of the lens O (magnification optical system 2). A virtual distance VID2 from the viewpoint of the viewer OB to the virtual image VIF of the second image displayed on the second liquid crystal display panel 20 corresponds to the distance a2 from the second liquid crystal display panel 20 to the center line of the lens O (magnification optical system 2). Thus, in the equivalent configuration of the HUD 100 illustrated in FIG. 4, the virtual distance VID1 from the viewpoint of the viewer OB to the virtual image VIR of the first image displayed on the first liquid crystal display panel 10 is greater than the virtual distance VID2 from the viewpoint of the viewer OB to the virtual image VIF of the second image displayed on the second liquid crystal display panel 20 (VID1>VID2).

With this configuration, the virtual image VIR of the first image displayed on the first liquid crystal display panel 10 is visually recognized at a virtual position farther from the viewer OB than the virtual image VIF of the second image displayed on the second liquid crystal display panel 20.

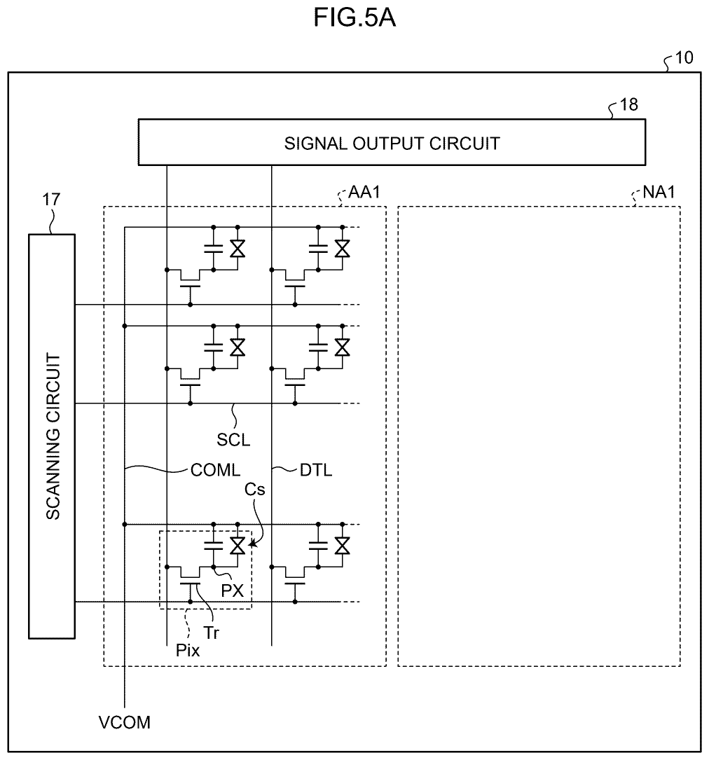

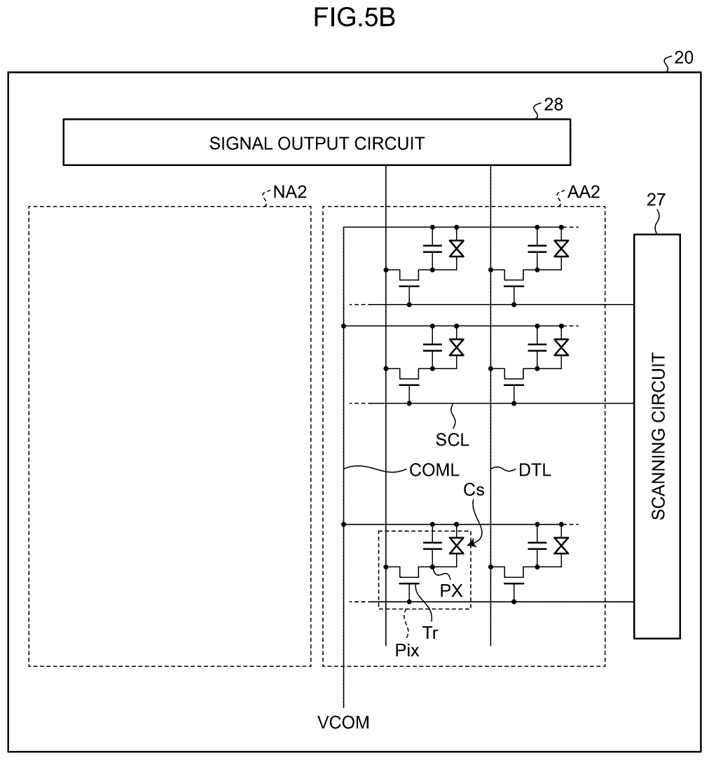

FIG. 5A is a schematic circuit diagram illustrating a main configuration of the first liquid crystal display panel. FIG. 5B is a schematic circuit diagram illustrating a main configuration of the second liquid crystal display panel. The first liquid crystal display panel 10 and the second liquid crystal display panel 20 are transmissive liquid crystal display panels and include, for example, a plurality of pixels Pix driven by an active matrix method.

The first liquid crystal display panel 10 includes a display region AA1, a non-display region NA1, a signal output circuit 18, and a scanning circuit 17. The display region AA1 is a region in which the first image is displayed in the first liquid crystal display panel 10. The non-display region NA1 is a region in which no image is displayed in the first liquid crystal display panel 10.

The second liquid crystal display panel 20 includes a display region AA2, a non-display region NA2, a signal output circuit 28, and a scanning circuit 27. The display region AA2 is a region in which the second image is displayed in the second liquid crystal display panel 20. The non-display region NA2 is a region in which no image is displayed in the second liquid crystal display panel 20.

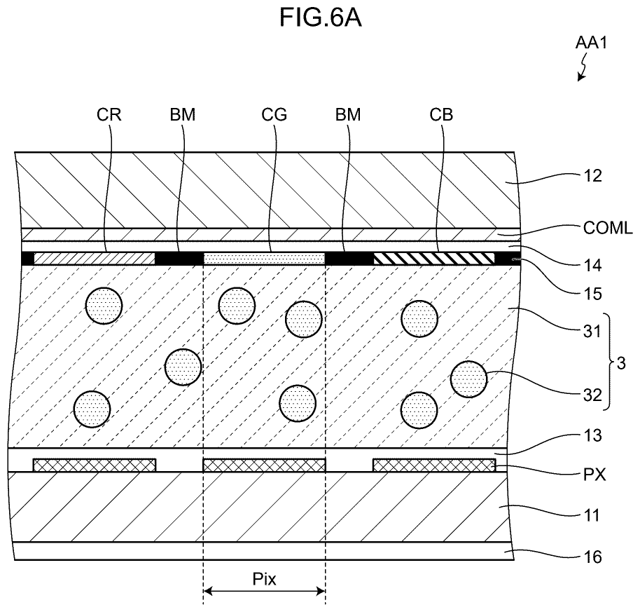

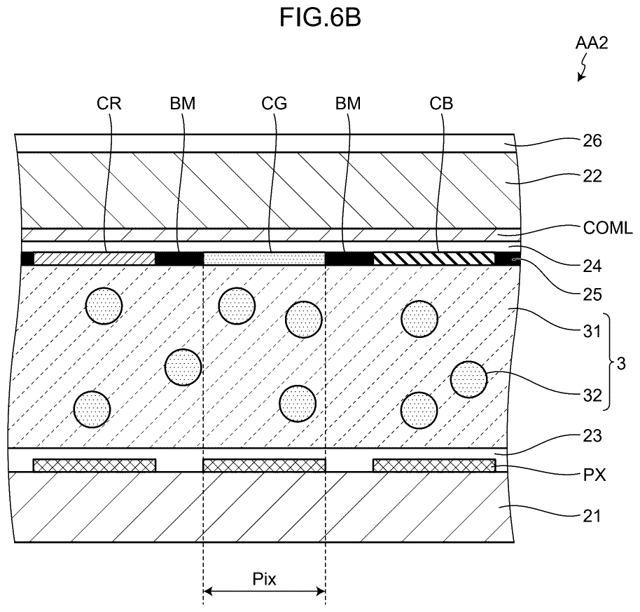

In the display region AA1 of the first liquid crystal display panel 10 and the display region AA2 of the second liquid crystal display panel 20, a plurality of pixels Pix are disposed in a matrix of a row and column configuration. Each pixel Pix includes a pixel transistor Tr and two electrodes. FIG. 6A is a schematic sectional view of the display region of the first liquid crystal display panel. FIG. 6B is a schematic sectional view of the display region of the second liquid crystal display panel.

The display region AA1 of the first liquid crystal display panel 10 is a region that overlaps the second liquid crystal display panel 20 and in which a liquid crystal layer 3 and a polarizing plate 16 are provided.

The display region AA2 of the second liquid crystal display panel 20 is a region that overlaps the first liquid crystal display panel 10 and in which a liquid crystal layer 3 and a polarizing plate 26 are provided.

The display region AA1 of the first liquid crystal display panel 10 and the display region AA2 of the second liquid crystal display panel 20 are regions in which color image display is possible in a plurality of colors.

The first liquid crystal display panel 10 includes a first substrate 11, a second substrate 12, and a liquid crystal layer 3 enclosed between the first substrate 11 and the second substrate 12. The first substrate 11 and the second substrate 12 are light-transmissive glass substrates.

In the display region AA1 of the first liquid crystal display panel 10, pixel electrodes PX are stacked on the liquid crystal layer 3 side of the first substrate 11, an insulating layer 13 is stacked on the liquid crystal layer 3 side of the pixel electrodes PX, and the polarizing plate 16 is bonded to the outer side of the first substrate 11.

In the display region AA1 of the first liquid crystal display panel 10, a common electrode COML is stacked on the liquid crystal layer 3 side of the second substrate 12, and an insulating layer 14 is stacked on the liquid crystal layer 3 side of the common electrode COML. In the display region AA1 of the first liquid crystal display panel 10, a color filter 15 is stacked on the liquid crystal layer 3 side of the insulating layer 14.

The second liquid crystal display panel 20 includes a first substrate 21, a second substrate 22, and a liquid crystal layer 3 enclosed between the first substrate 21 and the second substrate 22. The first substrate 21 and the second substrate 22 are light-transmissive glass substrates.

In the display region AA2 of the second liquid crystal display panel 20, pixel electrodes PX are stacked on the liquid crystal layer 3 side of the first substrate 21, and an insulating layer 23 is stacked on the liquid crystal layer 3 side of the pixel electrodes PX.

In the display region AA2 of the second liquid crystal display panel 20, a common electrode COML is stacked on the liquid crystal layer 3 side of the second substrate 22, an insulating layer 24 is stacked on the liquid crystal layer 3 side of the common electrode COML, and a polarizing plate 26 is bonded to the outer side of the second substrate 22. In the display region AA2 of the second liquid crystal display panel 20, a color filter 25 is stacked on the liquid crystal layer 3 side of the insulating layer 24.

The pixel electrode PX is a plate-shaped or film-shaped electrode and individually provided for each pixel Pix. The common electrode COML is a plate-shaped or film-shaped electrode and shared by a plurality of pixels Pix.

In each liquid crystal layer 3, as the potentials of the pixel electrodes PX are individually controlled for the respective pixels Pix, the alignment state of liquid crystal molecules 32 in a bulk 31 changes in accordance with the potential difference between each pixel electrode PX and the common electrode COML and a scattering state for each pixel Pix is controlled.

In the example illustrated in FIGS. 6A and 6B, the pixel electrodes PX provided on the first substrate 21 and the common electrode COML provided on the second substrate 22 are disposed to face each other across the liquid crystal layer 3, but the first liquid crystal display panel 10 and the second liquid crystal display panel 20 may each have a configuration in which the pixel electrodes PX and the common electrode COML are provided on one substrate, and the scattering state of the liquid crystal layer 3 may be controlled by changing alignment with an electric field generated by the pixel electrodes PX and the common electrode COML.

The following describes a mechanism for controlling the potentials of the pixel electrodes PX and the common electrode COML in each of the display region AA1 of the first liquid crystal display panel 10 and the display region AA2 of the second liquid crystal display panel 20.

Each pixel transistor Tr is a switching element using a semiconductor, such as a thin film transistor (TFT). One of the source and drain of the pixel transistor Tr is coupled to the pixel electrode PX. The other of the source and drain of the pixel transistor Tr is coupled to a signal line DTL. The gate of the pixel transistor Tr is coupled to a scanning line SCL. Under control by the scanning circuit 17 or 27, the scanning line SCL provides a drive potential for driving the pixel transistors Tr. The drive potential is controlled by the scanning circuit 17 or 27.

In the example illustrated in FIGS. 5A and 5B, a plurality of signal lines DTL are arranged in one (row direction) of the arrangement directions of the pixels Pix. The signal lines DTL extend in the other (column direction) of the arrangement directions of the pixels Pix. Each signal line DTL is shared by the pixel transistors Tr of a plurality of pixels Pix arranged in the column direction. A plurality of scanning lines SCL are arranged in the column direction. The scanning lines SCL extend in the row direction. Each scanning line SCL is shared by the pixel transistors Tr of a plurality of pixels Pix arranged in the row direction.

A common potential VCOM is applied to the common electrode COML. When the scanning circuit 17 or 27 supplies a drive potential for driving a pixel transistor Tr to a scanning line SCL and the pixel transistor Tr is controlled to be turned on, the signal output circuit 18 or 28 supplies a pixel signal to each signal line DTL. Accordingly, a voltage corresponding to the pixel signal is applied between the pixel electrode PX and the common electrode COML, and a pixel capacitor Cs is charged.

After the pixel transistor Tr is controlled to be turned off, the charged potential of the pixel capacitor Cs between the pixel electrode PX and the common electrode COML is held. The scattering degree of the liquid crystal layer 3 (liquid crystal molecules 32) is controlled in accordance with the charged potential of the pixel capacitor Cs between the pixel electrode PX and the common electrode COML for each pixel Pix.

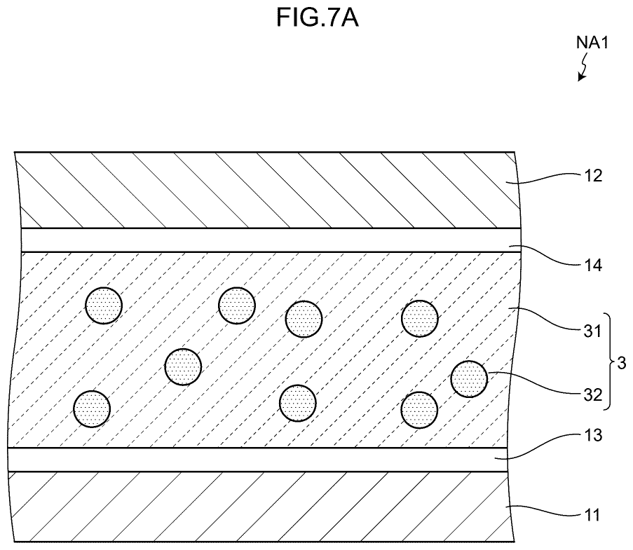

The following describes the non-display regions NA1 and NA2 according to the present disclosure. FIG. 7A is a schematic sectional view of the non-display region of the first liquid crystal display panel. FIG. 7B is a schematic sectional view of the non-display region of the second liquid crystal display panel.

Similarly to the display region AA1 of the first liquid crystal display panel 10, the non-display region NA1 of the first liquid crystal display panel 10 is a region that overlaps the second liquid crystal display panel 20 and in which a liquid crystal layer 3 and the polarizing plate 16 are provided. Similarly to the display region AA2 of the second liquid crystal display panel 20, the non-display region NA2 of the second liquid crystal display panel 20 is a region that overlaps the first liquid crystal display panel 10 and in which a liquid crystal layer 3 and the polarizing plate 26 are provided. However, no pixels Pix are provided in the non-display region NA1 of the first liquid crystal display panel 10 and the non-display region NA2 of the second liquid crystal display panel 20.

Specifically, as illustrated in FIG. 7A, the pixel electrodes PX stacked on the liquid crystal layer 3 side of the first substrate 11 in the display region AA1 of the first liquid crystal display panel 10 are not provided in the non-display region NA1 of the first liquid crystal display panel 10. The common electrode COML stacked on the liquid crystal layer 3 side of the second substrate 12 and the color filter 15 stacked on the liquid crystal layer 3 side of the insulating layer 14 in the display region AA1 of the first liquid crystal display panel 10 are not provided in the non-display region NA1 of the first liquid crystal display panel 10.

As illustrated in FIG. 7B, the pixel electrodes PX stacked on the liquid crystal layer 3 side of the first substrate 21 in the display region AA2 of the second liquid crystal display panel 20 are not provided in the non-display region NA2 of the second liquid crystal display panel 20. The common electrode COML stacked on the liquid crystal layer 3 side of the second substrate 22 and the color filter 25 stacked on the liquid crystal layer 3 side of the insulating layer 24 in the display region AA2 of the second liquid crystal display panel 20 are not provided in the non-display region NA2 of the second liquid crystal display panel 20.

Moreover, as illustrated in FIGS. 5A and 5B, no pixel transistors Tr are provided in the non-display region NA1 of the first liquid crystal display panel 10 and the non-display region NA2 of the second liquid crystal display panel 20. Furthermore, no scanning line SCL for applying a drive potential to a pixel transistor Tr and no signal line DTL for supplying a pixel signal to a pixel transistor Tr are provided in the non-display region NA1 of the first liquid crystal display panel 10 and the non-display region NA2 of the second liquid crystal display panel 20.

In the present disclosure, as described above, the first liquid crystal display panel 10 and the second liquid crystal display panel 20 are disposed overlapping when viewed in the optical axis direction (Z direction) of the magnification optical system. Specifically, the second liquid crystal display panel 20 is disposed with a gap S interposed between the first liquid crystal display panel 10 and the second liquid crystal display panel 20. Direct light from the backlight 30 is incident on the first liquid crystal display panel 10. Light transmitted through the first liquid crystal display panel 10 is incident on the second liquid crystal display panel 20.

As described above, in the display device 1 according to the embodiment, the insulating layer 13 and the color filter 15 are provided in the display region AA1 of the first liquid crystal display panel 10. The color filter 15 is provided between the polarizing plate 16 and the second liquid crystal display panel 20.

As described above, in the display device 1 according to the embodiment, the insulating layer 24 and the color filter 25 are provided in the display region AA2 of the second liquid crystal display panel 20. The color filter 25 is provided between the polarizing plate 26 and the first liquid crystal display panel 10.

When incident light passes through the first liquid crystal display panel 10, the light quantity of the incident light is adjusted in accordance with the gradation value of each pixel Pix provided at a position corresponding to a display image on the first liquid crystal display panel 10, and the incident light is emitted as transmitted light. When incident light passes through the second liquid crystal display panel 20, the light quantity of the incident light is adjusted in accordance with the gradation value of each pixel Pix provided at a position corresponding to a display image on the second liquid crystal display panel 20, and the incident light is emitted as transmitted light.

The polarizing plate 16 is an optical member that transmits light polarized in a first direction and blocks light polarized in a direction different from the first direction. Specifically, the polarizing plate 16 is, for example, a linear polarizing plate having a transmission axis in a Y direction.

The polarizing plate 26 is an optical member that transmits light polarized in a second direction different from the first direction and blocks light polarized in a direction different from the second direction. Specifically, the polarizing plate 26 is, for example, a linear polarizing plate having a transmission axis in an X direction.

In the present disclosure, no polarizing plate is provided between the first liquid crystal display panel 10 and the second liquid crystal display panel 20, and the polarizing plate 16 and the polarizing plate 26 are disposed in a state (cross Nicol) in which their transmission axes are orthogonal to each other with respect to incident light. The liquid crystal layers 3 of the first liquid crystal display panel 10 and the second liquid crystal display panel 20 are initially aligned such that their transmittances are maximized. This configuration maximizes the transmittance in each of the non-display region NA1 of the first liquid crystal display panel 10 and the non-display region NA2 of the second liquid crystal display panel 20.

The color filters 15 and 25 each include a red color resist CR that transmits red light, a green color resist CG that transmits green light, and a blue color resist CB that transmits blue light. The color resists in the respective colors are provided in correspondence with the respective pixels Pix of the first liquid crystal display panel 10 and the second liquid crystal display panel 20. A light-shielding film BM is provided between the color resists in the respective colors.

With the above-described configuration, a color image (first image) displayed in the display region AA1 of the first liquid crystal display panel 10 passes through the second liquid crystal display panel 20 and is visually recognized by the viewer OB as the virtual image VIF.

With the above-described configuration, a color image (second image) displayed in the display region AA2 of the second liquid crystal display panel 20 is visually recognized by the viewer OB as the virtual image VIR, which is formed by the transmitted light from the first liquid crystal display panel 10.

In a case where the display region AA1 of the first liquid crystal display panel 10 and the display region AA2 of the second liquid crystal display panel 20 overlap when viewed in the Z direction, the chromaticity of the virtual image VIR of the first image visually recognized by the viewer OB changes due to the color filter 25 provided in the display region AA2 of the second liquid crystal display panel 20. The chromaticity of transmitted light that is transmitted through the display region AA1 of the first liquid crystal display panel 10 and incident on the display region AA2 of the second liquid crystal display panel 20, changes due to the color filter 15 provided in the display region AA1 of the first liquid crystal display panel 10.

Thus, the chromaticity of the virtual image VIF of the second image visually recognized by the viewer OB changes due to the color filter 15 provided in the display region AA1 of the first liquid crystal display panel 10. Furthermore, the luminance of the virtual image VIR of the first image and the luminance of the virtual image VIF of the second image visually recognized by the viewer OB decrease due to decrease in transmittance and aperture ratio, resulting from the color filters 15 and 25 being doubly provided.

Thus, in the present disclosure, the display region AA1 of the first liquid crystal display panel 10 and the display region AA2 of the second liquid crystal display panel 20 do not overlap when viewed in at least one direction in which the first liquid crystal display panel 10 and the second liquid crystal display panel 20 are placed so as to overlap each other, specifically, the optical axis direction (Z direction) of the magnification optical system. In other words, when viewed in at least one direction in which the first liquid crystal display panel 10 and the second liquid crystal display panel 20 are placed so as to overlap each other, specifically, the optical axis direction (Z direction) of the magnification optical system, the display region AA1 of the first liquid crystal display panel 10 and the non-display region NA2 of the second liquid crystal display panel 20 overlap, and the display region AA2 of the second liquid crystal display panel 20 and the non-display region NA1 of the first liquid crystal display panel 10 overlap. With this configuration, it is possible to reduce degradation of the display qualities of the virtual image VIR of the first image and the virtual image VIF of the second image reflected by the light-transmissive member FG and visually recognized by the viewer OB. The following describes specific examples of the configurations of the first liquid crystal display panel 10 and the second liquid crystal display panel 20 in the display device 1 according to the present disclosure.

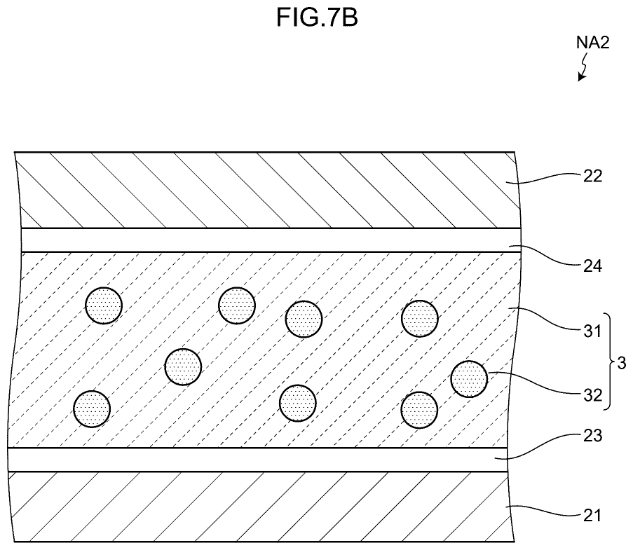

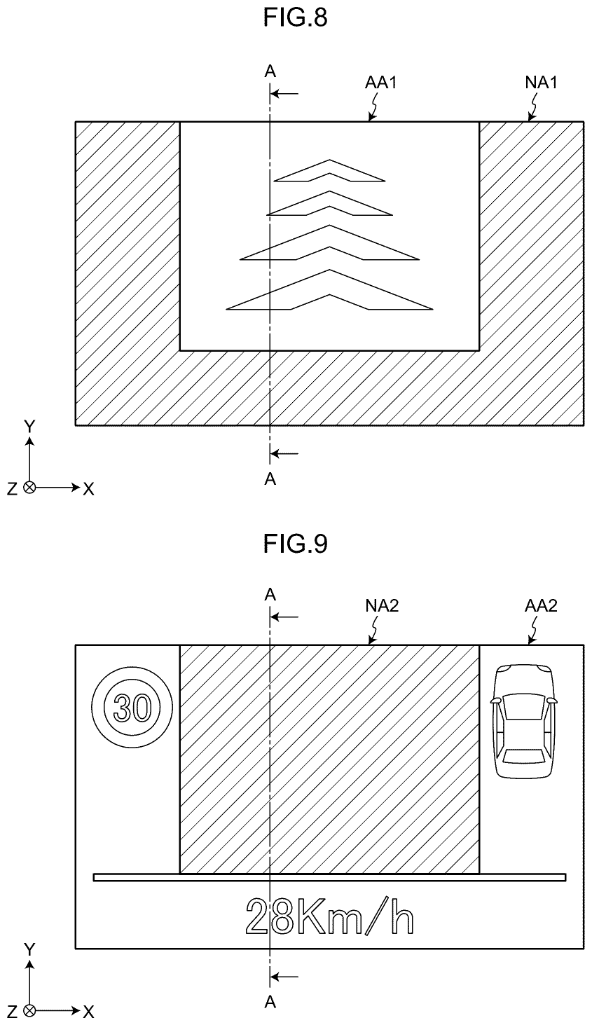

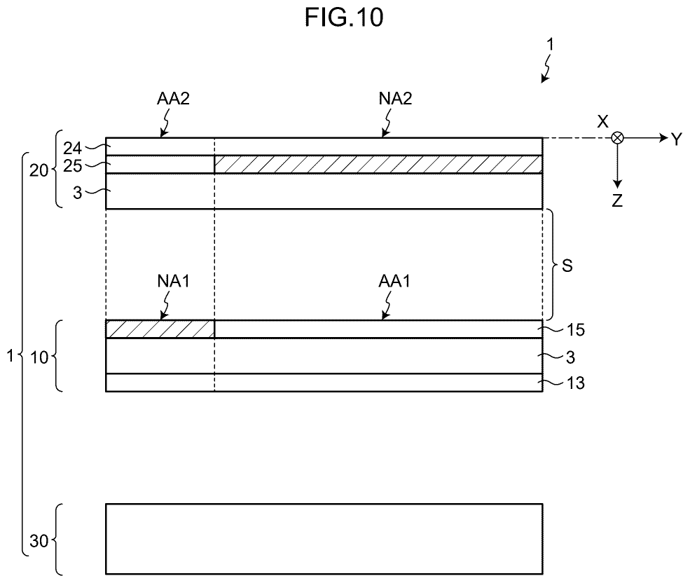

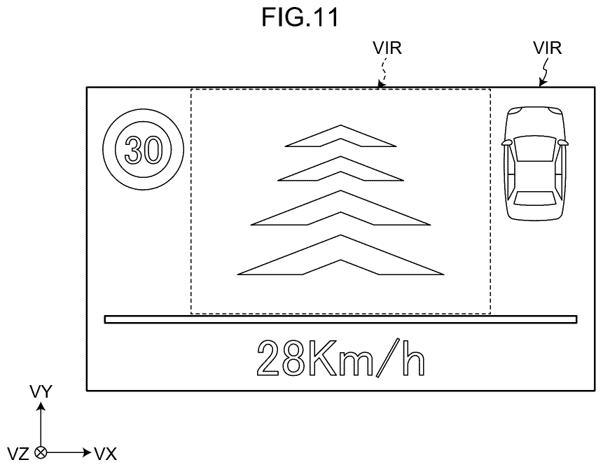

FIG. 8 is a diagram illustrating a display aspect of the first image in a first example. FIG. 9 is a diagram illustrating a display aspect of the second image in the first example. FIG. 10 is a sectional view of the display device according to the embodiment along line A-A illustrated in FIGS. 8 and 9, viewed in the direction of arrows. FIG. 11 is a diagram illustrating the virtual image visually recognized by the viewer in the first example.

The hatched region in FIG. 8 represents the non-display region NA1 of the first liquid crystal display panel 10. The first image is displayed in the display region AA1 of the first liquid crystal display panel 10.

The hatched region in FIG. 9 represents the non-display region NA2 of the second liquid crystal display panel 20. The second image is displayed in the display region AA2 of the second liquid crystal display panel 20.

The first example illustrated in FIGS. 8, 9, and 11 is an example configured such that, when viewed in at least the direction in which the first liquid crystal display panel 10 and the second liquid crystal display panel 20 are placed so as to overlap each other, as illustrated in FIG. 10, the display region AA1 of the first liquid crystal display panel 10 overlaps the non-display region NA2 of the second liquid crystal display panel 20, and the display region AA2 of the second liquid crystal display panel 20 overlaps the non-display region NA1 of the first liquid crystal display panel 10. More specifically, the display region AA1 of the first liquid crystal display panel 10 and the non-display region NA2 of the second liquid crystal display panel 20 overlap when viewed in the optical axis direction (Z direction) of the magnification optical system, and the display region AA2 of the second liquid crystal display panel 20 and the non-display region NA1 of the first liquid crystal display panel 10 overlap when viewed in the optical axis direction (Z direction) of the magnification optical system. With this configuration, as illustrated in FIG. 11, the virtual image VIR of the first image displayed in the display region AA1 of the first liquid crystal display panel 10 and the virtual image VIF of the second image displayed in the display region AA2 of the second liquid crystal display panel 20 are visually recognized without overlapping when viewed in the line-of-sight direction of the viewer OB.

In the present disclosure, as described above, no polarizing plate is provided between the first liquid crystal display panel 10 and the second liquid crystal display panel 20, and the polarizing plate 16 and the polarizing plate 26 are disposed in a state (cross Nicol) in which their transmission axes are orthogonal to each other with respect to incident light. The liquid crystal layer 3 of the first liquid crystal display panel 10 is initially aligned such that the transmittance of the non-display region NA1 of the first liquid crystal display panel 10 is maximized. With this configuration, it is possible to reduce degradation of the display quality of the second image visually recognized by the viewer OB.

Specifically, by not providing the color filter 15 in at least the non-display region NA1 of the first liquid crystal display panel 10, it is possible to reduce chromaticity change and luminance decrease of the virtual image VIF of the second image visually recognized by the viewer OB. Moreover, by not providing the pixel electrodes PX, the common electrode COML, the pixel transistors Tr, the scanning lines SCL, the signal lines DTL, and the like in the non-display region NA1 of the first liquid crystal display panel 10, it is possible to further reduce luminance decrease of the virtual image VIF of the second image visually recognized by the viewer OB.

In the present disclosure, as described above, the liquid crystal layer 3 of the second liquid crystal display panel 20 is initially aligned such that the transmittance of the non-display region NA2 of the second liquid crystal display panel 20 is maximized. With this configuration, it is possible to reduce degradation of the display quality of the first image visually recognized by the viewer OB.

Specifically, by not providing the color filter 25 in at least the non-display region NA2 of the second liquid crystal display panel 20, it is possible to reduce chromaticity change and luminance decrease of the virtual image VIR of the first image visually recognized by the viewer OB. Moreover, by not providing the pixel electrodes PX, the common electrode COML, the pixel transistors Tr, the scanning lines SCL, the signal lines DTL, and the like in the non-display region NA2 of the second liquid crystal display panel 20, it is possible to further reduce luminance decrease of the virtual image VIR of the first image visually recognized by the viewer OB.

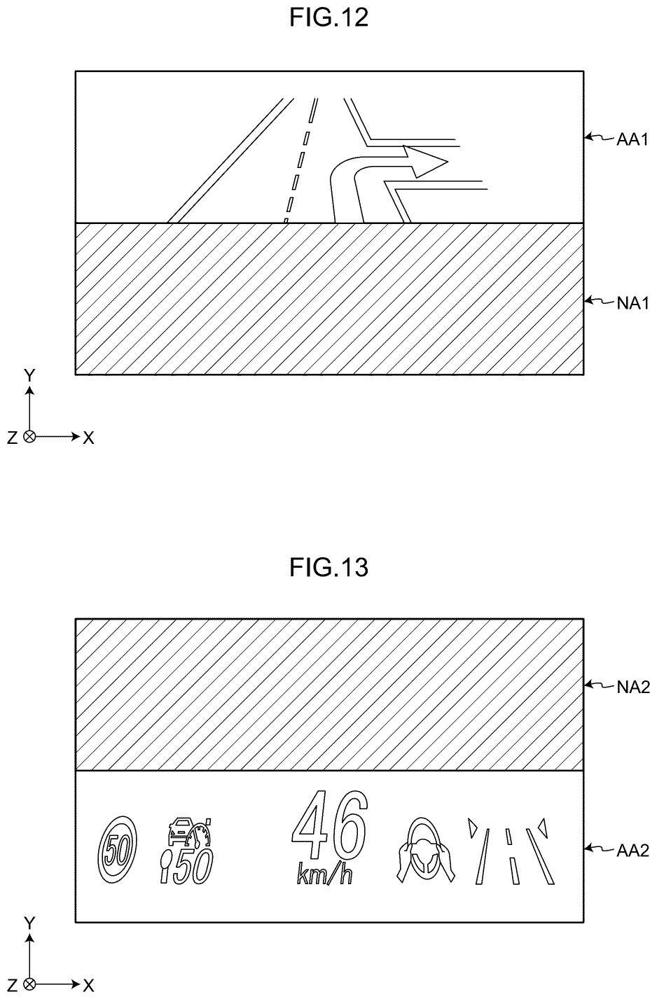

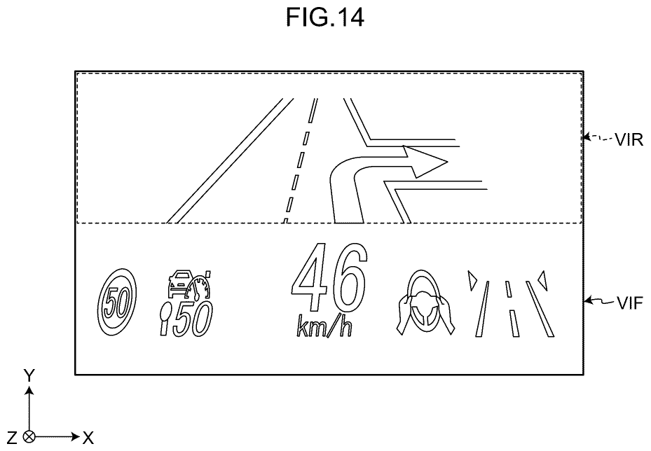

FIG. 12 is a diagram illustrating the display aspect of the first image in a second example. FIG. 13 is a diagram illustrating the display aspect of the second image in the second example. FIG. 14 is a diagram illustrating the virtual image visually recognized by the viewer in the second example.

In the second example illustrated in FIGS. 12, 13, and 14, the first liquid crystal display panel 10 and the second liquid crystal display panel 20 are disposed such that their display and non-display regions are symmetric with respect to each other. With this configuration, it is possible to constitute the display device 1 by using two identical liquid crystal display panels.

In the second example illustrated in FIGS. 12, 13, and 14, the display and non-display regions are symmetrically disposed in a vertical direction, but the present disclosure is not limited thereto. Specifically, for example, the display and non-display regions may be symmetrically disposed in a lateral direction or in a diagonal direction.

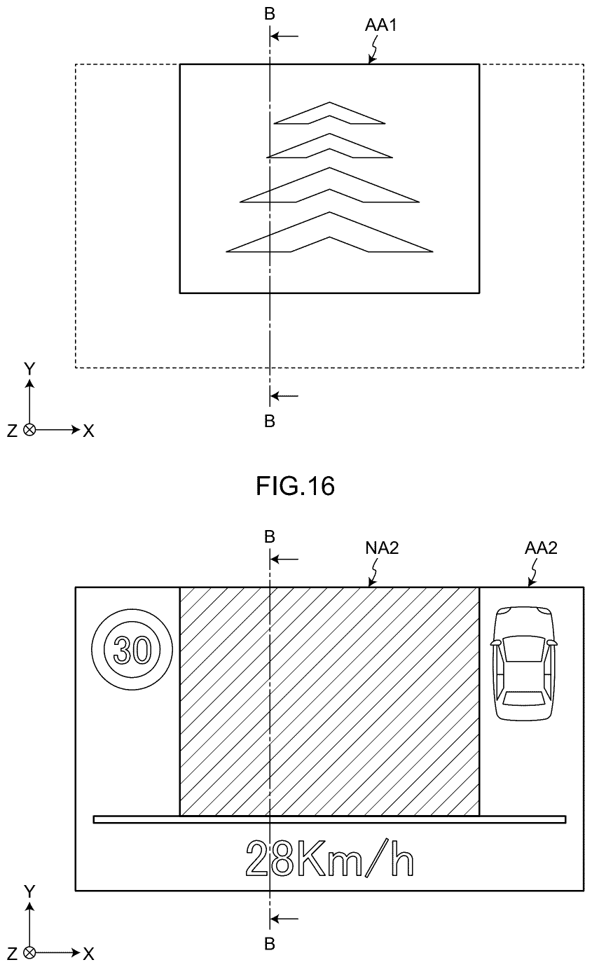

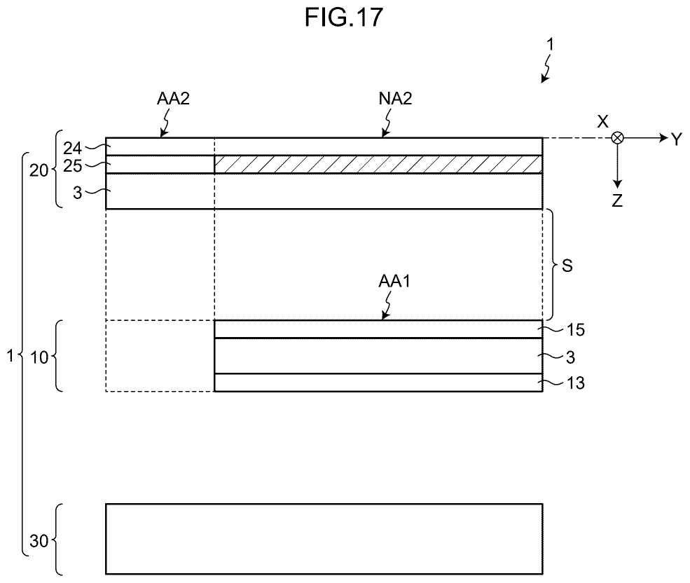

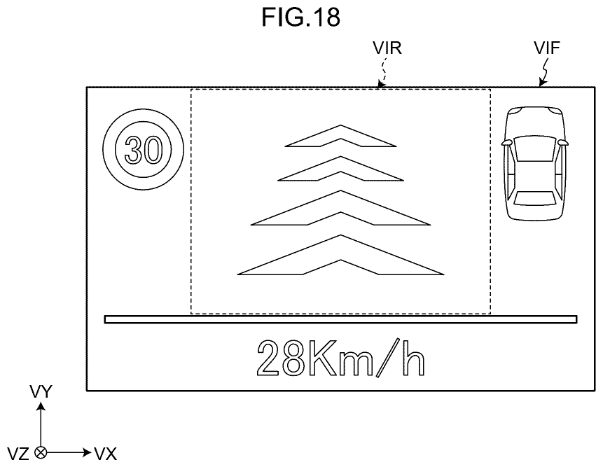

FIG. 15 is a diagram illustrating the display aspect of the first image in a third example. FIG. 16 is a diagram illustrating the display aspect of the second image in the third example. FIG. 17 is a sectional view of the display device according to the embodiment along line B-B illustrated in FIGS. 15 and 16, viewed in the direction of arrows. FIG. 18 is a diagram illustrating the virtual image visually recognized by the viewer in the third example.

In the third example illustrated in FIGS. 15, 16, and 18, no non-display region is provided in the first liquid crystal display panel 10.

In the third example illustrated in FIGS. 15, 16, and 18, as well, the display region AA1 of the first liquid crystal display panel 10 and the non-display region NA2 of the second liquid crystal display panel 20 overlap as illustrated in FIG. 17 when viewed in at least the direction in which the first liquid crystal display panel 10 and the second liquid crystal display panel 20 are placed so as to overlap each other. More specifically, the display region AA1 of the first liquid crystal display panel 10 and the non-display region NA2 of the second liquid crystal display panel 20 overlap when viewed in the optical axis direction (Z direction) of the magnification optical system. With this configuration, the virtual image VIR of the first image displayed in the display region AA1 of the first liquid crystal display panel 10 and the virtual image VIF of the second image displayed in the display region AA2 of the second liquid crystal display panel 20 are visually recognized without overlapping when viewed in the line-of-sight direction of the viewer OB.

In the present disclosure, as described above, the liquid crystal layer 3 of the second liquid crystal display panel 20 is initially aligned such that the transmittance of the non-display region NA2 of the second liquid crystal display panel 20 is maximized. With this configuration, it is possible to reduce degradation of the display qualities of the first and second images visually recognized by the viewer OB.

Specifically, by not providing the color filter 25 in at least the non-display region NA2 of the second liquid crystal display panel 20, it is possible to reduce chromaticity change and luminance decrease of the virtual image VIR of the first image visually recognized by the viewer OB. Moreover, by not providing the pixel electrodes PX, the common electrode COML, the pixel transistors Tr, the scanning lines SCL, the signal lines DTL, and the like in the non-display region NA2 of the second liquid crystal display panel 20, it is possible to further reduce luminance decrease of the virtual image VIR of the first image visually recognized by the viewer OB.

### First Modification

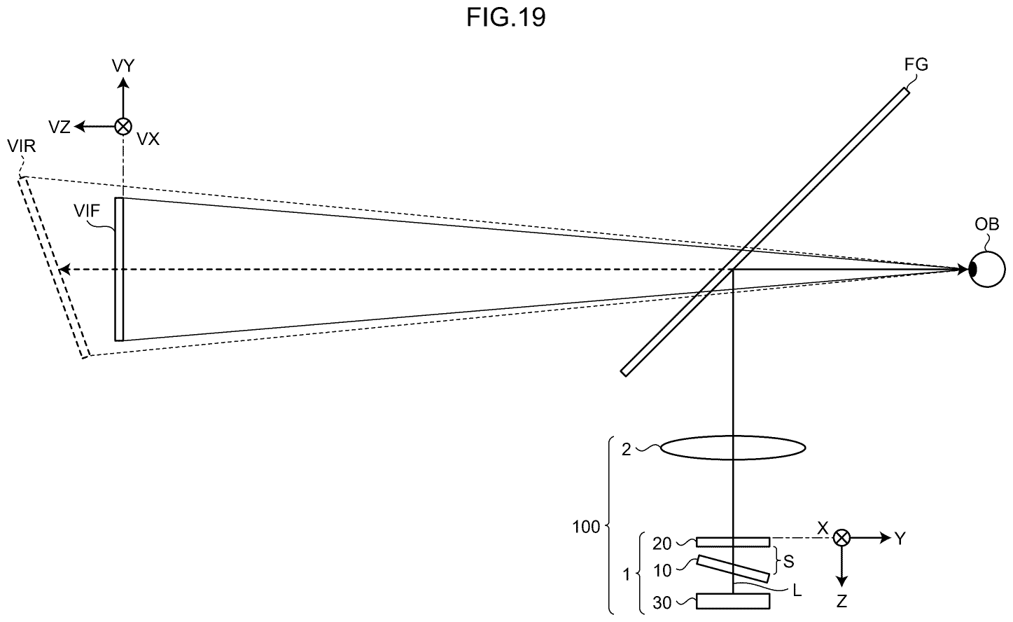

FIG. 19 is a schematic diagram of a HUD, illustrating an example of application of a display device according to a first modification of the embodiment. The following describes configurations different from those in the first embodiment and omits duplicate description thereof in some cases.

In a configuration according to the first modification of the embodiment, the first liquid crystal display panel 10 is disposed in a state of being inclined with respect to the second liquid crystal display panel 20. The second liquid crystal display panel 20 is disposed in substantially parallel to the X-Y plane perpendicular to the optical axis of the magnification optical system 2. The inclination angle of the first liquid crystal display panel 10 with respect to the second liquid crystal display panel 20 (X-Y plane perpendicular to the optical axis of the magnification optical system 2) is, for example, 40 deg approximately. With this configuration, the virtual image VIR of the first image displayed on the first liquid crystal display panel 10 is visually recognized by the viewer OB in a state of being inclined with respect to the virtual image VIF of the second image displayed on the second liquid crystal display panel 20.

More specifically, in the configuration illustrated in FIG. 19 according to the first modification of the embodiment, the virtual image VIR of the first image is visually recognized as being inclined from front to back in the upward direction at the viewpoint of the viewer OB.

To achieve such a display aspect, the first liquid crystal display panel 10 is disposed in a state of being inclined with respect to the X-Y plane substantially parallel to the second liquid crystal display panel 20 such that the gap S between the first liquid crystal display panel 10 and the second liquid crystal display panel 20 is larger at an upper end part in the Y direction and smaller at a lower end part in the Y direction (refer to FIG. 19).

In this manner, with the configuration according to the first modification of the embodiment, it is possible to allow visual recognition in a state in which the virtual image VIR of the first image is inclined with respect to the virtual image VIF of the second image in a region where the virtual image VIR of the first image and the virtual image VIF of the second image are visually recognized by the viewer OB in a state of overlapping when viewed in the line-of-sight direction of the viewer OB.

Moreover, since the first liquid crystal display panel 10 is disposed in a state of being inclined with respect to the X-Y plane substantially parallel to the second liquid crystal display panel 20 such that the gap S between the first liquid crystal display panel 10 and the second liquid crystal display panel 20 is larger at the upper end part in the Y direction and smaller at the lower end part in the Y direction, it is possible to allow visually recognition of the virtual image VIR of the first image as being inclined from front to back in the upward direction at the viewpoint of the viewer OB.

### Second Modification

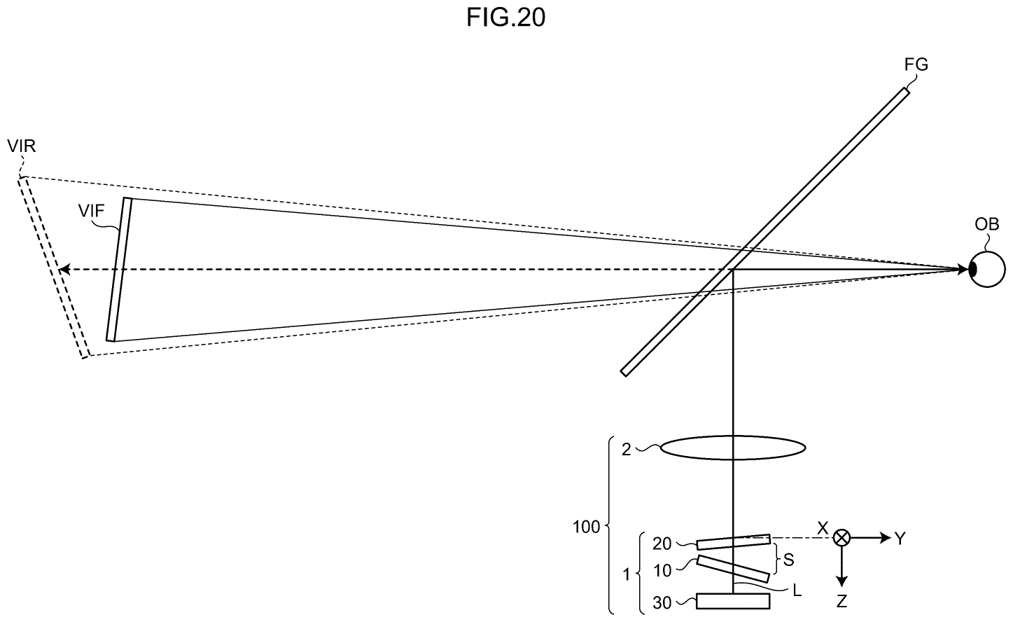

FIG. 20 is a schematic diagram of a HUD, illustrating an example of application of a display device according to a second modification of the embodiment. The following describes configurations different from those in the first embodiment and omits duplicate description thereof in some cases.

In a configuration according to the second modification of the embodiment, the second liquid crystal display panel 20 is disposed in a state of being inclined with respect to the X-Y plane perpendicular to the optical axis of the magnification optical system 2.

In the second modification illustrated in FIG. 20, the inclination direction of the second liquid crystal display panel 20 with respect to the X-Y plane is, for example, a direction obtained by rotating 180 deg in the X-Y plane from the inclination direction of the first liquid crystal display panel 10 with respect to the X-Y plane.

The inclination angle of the second liquid crystal display panel 20 with respect to the X-Y plane may be smaller than the inclination angle of the first liquid crystal display panel 10 with respect to the X-Y plane. Specifically, for example, the inclination angle of the second liquid crystal display panel 20 with respect to the X-Y plane is approximately 20 deg in a case where the inclination angle of the first liquid crystal display panel 10 with respect to the X-Y plane is approximately 40 deg. With this configuration, sunlight incident in the optical axis direction of the magnification optical system 2 is reflected in a direction deviating from the optical axis of the magnification optical system 2 at the surface of the second liquid crystal display panel 20 (surface of the polarizing plate 26). Accordingly, the sunlight reflected by the surface of the second liquid crystal display panel 20 (surface of the polarizing plate 26) can be prevented from being incident on the eyes of the viewer OB.

The inclination direction of the second liquid crystal display panel 20 is not limited to the aspect illustrated in FIG. 20. Specifically, for example, the inclination direction of the second liquid crystal display panel 20 with respect to the X-Y plane may be identical to the inclination direction of the first liquid crystal display panel 10 with respect to the X-Y plane. The present disclosure is not limited by the inclination direction of the second liquid crystal display panel 20.

Preferable embodiments of the present disclosure are described above, but the present disclosure is not limited to such embodiments. Contents disclosed in the embodiments are merely exemplary, and various kinds of modifications are possible without departing from the scope of the present disclosure. For example, any modification performed as appropriate without departing from the scope of the present disclosure belongs to the technical scope of the present invention.

What is claimed is:

1. A display device comprising:
a backlight;
a first liquid crystal display panel on which direct light from the backlight is incident; and
a second liquid crystal display panel that is placed, with a gap interposed between the first liquid crystal display panel and the second liquid crystal display panel, so as to overlap the first liquid crystal display panel and on which transmitted light from the first liquid crystal display panel is incident, wherein
the first liquid crystal display panel includes a display region for displaying an image,
the second liquid crystal display panel includes a display region for displaying an image and a non-display region for not displaying an image,
the display region of the first liquid crystal display panel overlaps the non-display region of the second liquid crystal display panel when viewed in at least one direction in which the first and second liquid crystal display panels are placed so as to overlap each other,
the display region of the first liquid crystal display panel is provided with at least a liquid crystal layer, a polarizing plate, and a color filter, and
the non-display region of the second liquid crystal display panel is provided with at least a liquid crystal layer and a polarizing plate and is not provided with a color filter.

2. The display device according to claim 1, wherein
a pixel transistor for applying a voltage to the liquid crystal layer is provided in the display region of the first liquid crystal display panel, and
no pixel transistor is provided in the non-display region of the second liquid crystal display panel.

3. The display device according to claim 2, wherein
a pixel electrode coupled to the pixel transistor is provided in the display region of the first liquid crystal display panel, and
no pixel electrode is provided in the non-display region of the second liquid crystal display panel.

4. The display device according to claim 3, wherein
a common electrode facing the pixel electrode with the liquid crystal layer between the common electrode and the pixel electrode is provided in the display region of the first liquid crystal display panel, and
no common electrode is provided in the non-display region of the second liquid crystal display panel.

5. The display device according to claim 4, wherein
a scanning line for applying a drive potential to the pixel transistor and a signal line for supplying a pixel signal to the pixel transistor when the pixel transistor is controlled to be turned on through application of the drive potential, are provided in the display region of the first liquid crystal display panel, and
no scanning line and no signal line are provided in the non-display region of the second liquid crystal display panel.

6. The display device according to claim 1, wherein
the first liquid crystal display panel includes a non-display region in which image display is not possible,
the non-display region of the first liquid crystal display panel overlaps the display region of the second liquid crystal display panel when viewed in at least one direction in which the first and second liquid crystal display panels are placed so as to overlap each other,
the display region of the second liquid crystal display panel is provided with at least a liquid crystal layer, a polarizing plate, and a color filter, and
the non-display region of the first liquid crystal display panel is provided with at least a liquid crystal layer and a polarizing plate and is not provided with a color filter.

7. The display device according to claim 6, wherein
a pixel transistor for applying a voltage to the liquid crystal layer is provided in the display region of the second liquid crystal display panel, and
no pixel transistor is provided in the non-display region of the first liquid crystal display panel.

8. The display device according to claim 7, wherein
a pixel electrode coupled to the pixel transistor is provided in the display region of the second liquid crystal display panel, and
no pixel electrode is provided in the non-display region of the first liquid crystal display panel.

9. The display device according to claim 8, wherein
a common electrode facing the pixel electrode with the liquid crystal layer between the common electrode and the pixel electrode is provided in the display region of the second liquid crystal display panel, and
no common electrode is provided in the non-display region of the first liquid crystal display panel.

10. The display device according to claim 9, wherein
a scanning line for applying a drive potential to the pixel transistor and a signal line for supplying a pixel signal to the pixel transistor when the pixel transistor is controlled to be turned on through application of the drive potential, are provided in the display region of the second liquid crystal display panel, and
no scanning line and no signal line are provided in the non-display region of the first liquid crystal display panel.

11. The display device according to claim 1, wherein
the polarizing plate provided in the first liquid crystal display panel and the polarizing plate provided in the second liquid crystal display panel are disposed such that transmission axes of the polarizing plates are orthogonal to each other with respect to incident light, and
the liquid crystal layer provided in the first liquid crystal display panel and the liquid crystal layer provided in the second liquid crystal display panel are initially aligned such that transmittances of the first and second liquid crystal display panels are maximized.

12. The display device according to claim 11, wherein no additional polarizing plate is provided between the first and second liquid crystal display panels.

13. A head-up display that configured to cause a viewer to visually recognize, as a virtual image, an image reflected by a light-transmissive member that transmits and reflects incident light and superimposed on a real image transmitted through the light-transmissive member, the head-up display comprising:
the display device according to claim 1; and
a magnification optical system that magnifies an image displayed on the display device and projects the image onto the light-transmissive member, wherein
a polarizing plate provided in the first liquid crystal display panel and a polarizing plate provided in the second liquid crystal display panel are disposed such that transmission axes of the polarizing plates are orthogonal to each other with respect to incident light, and
a liquid crystal layer provided in the first liquid crystal display panel and a liquid crystal layer provided in the second liquid crystal display panel are initially aligned such that transmittances of the first and second liquid crystal display panels are maximized.

14. The head-up display according to claim 13, wherein no additional polarizing plate is provided between the first and second liquid crystal display panels.

15. The head-up display according to claim 14, wherein a virtual distance from a viewpoint of the viewer to a virtual image of a first image displayed on the first liquid crystal display panel is greater than a virtual distance from the viewpoint of the viewer to a virtual image of a second image displayed on the second liquid crystal display panel.

16. The head-up display according to claim 15, wherein the first and second liquid crystal display panels overlap when viewed in a line-of-sight direction of the viewer.

17. The head-up display according to claim 16, wherein the first liquid crystal display panel is disposed inclined with respect to a plane perpendicular to the line-of-sight direction of the viewer.

18. The head-up display according to claim 16, wherein the second liquid crystal display panel is disposed inclined with respect to a plane perpendicular to the line-of-sight direction of the viewer.

19. The head-up display according to claim 16, wherein the first liquid crystal display panel is disposed inclined with respect to the second liquid crystal display panel.
